(19) United States
(12) Patent Application Publication
(10) Pub. No.: US 2012/0110310 A1
(43) Pub. Date: May 3, 2012

(54) MICROPROCESSOR WITH PIPELINE BUBBLE DETECTION DEVICE

(76) Inventors: Andreas Kirschbaum, Griesheim (DE); Lukusa Didier Kabulepa, Erzhausen (DE)

(21) Appl. No.: 13/061,832

(22) PCT Filed: Sep. 1, 2009
(86) PCT No.: PCT/EP2009/061299

§ 371 Date: May 27, 2011

(30) Foreign Application Priority Data
Sep. 4, 2008 (DE) 10 2008 045 767.1

(51) Int. Cl. G06F 9/38

(52) U.S. Cl. 712/227; 712/E09.062

(57) ABSTRACT

A microprocessor includes a pipeline microarchitecture and a pipeline bubble detection device. The pipeline bubble detection device has a minimum execution clock cycle ascertainment unit for ascertaining a minimum or optimum number of execution clock cycles for one or more program commands which pass through the pipeline microarchitecture or are handled by the pipeline microarchitecture.

### CROSS REFERENCE TO RELATED APPLICATIONS

This application claims priority to German Patent Application No. 102008045767.1, filed Sep. 4, 2008 and PCT/EP2009/061299, filed Sep. 1 , 2009.

### BACKGROUND

1. Field of the Invention

The invention relates to a microprocessor and a method for actuating a microprocessor in motor vehicles.

2. Description of the Known Art

Pipeline microarchitectures or pipelines are a known way of increasing the performance of the processing core in microprocessors. In this case, the execution of machine commands is broken down into successive task elements which are performed with an overlap. This overlap allows an increase in the throughput during the execution of program commands or machine commands. The number of commands executed per clock cycle or clock unit can be increased further by expanding the pipeline functionality. One possible expansion is provided by superscalar technology, for example. This technology is used to transfer multiple machine commands from a command sequence simultaneously by means of dynamic allocation to parallel-operating functional units. The microprocessor handles the dynamic allocation itself during the execution of the commands. This means that the dynamic allocation does not take place during the actual compiling.

VLIW (Very Long Instruction Word) technology is an alternative expansion option for the pipeline functionality. In contrast to superscalar technology, VLIW technology does not involve the commands being allocated to the individual functional units by the processor dynamically at runtime, but rather the compiler groups commands which can be executed in parallel.

Even using one of the abovementioned expansions, the performance of a pipeline microarchitecture can be impaired by pipeline conflicts, also called pipeline hazards. The occurrence of a pipeline conflict can result in the pipeline execution being temporarily stopped, which is also called a pipeline stall. A pipeline stall does not involve the entire pipeline being blocked. While an instruction is stopped, typically only the execution of the subsequent commands is slowed down, whereas the preceding commands continue to be executed. The resultant gaps in the pipeline execution are called pipeline bubbles.

The following pipeline conflicts can arise by way of example in a pipeline microarchitecture:
Resource conflicts (structural hazards): this case arises by way of example when two different pipeline stages wish to access the same resource, such as the same single-port memory, simultaneously.
Data dependencies (data hazards): a subsequent command waits for a previous command to update data in a register, for example.
Conflicts in the control flow (control hazards): control flow conflicts, where the destination address for a branch command is obtained from data from other commands and therefore the execution of the branch command can be slowed down by the evaluation time for these data from other commands, for example. In order to prevent the pipeline execution from being stopped in this regard, branch predictions are used or implemented, for example, which speculatively calculate the branch address in advance. The execution continues without interruption if the prediction has been found to be correct. If a branch prediction is incorrect, however, commands executed in the meantime must be rejected (pipeline flush). This takes up a large amount of time, particularly for long pipeline microarchitectures. When the pipeline is refilled, this automatically results in pipeline bubbles in some pipeline stages.

In order to reduce pipeline bubbles, various techniques are already known which act in the compiler or in the hardware implementation of the pipeline or in the pipeline microarchitecture. For the compiler, a set of configuration parameters is usually sought which keeps the frequency of pipeline conflicts to a minimum for a prescribed application. On the hardware side, additional precautions are usually implemented in the pipeline microarchitecture in order to prevent the occurrence of pipeline bubbles as far as possible or in order to promote faster resolution of pipeline conflicts in the processor.

### SUMMARY

The invention is based on the object of proposing a microprocessor and a method for actuating a microprocessor which allows improved avoidance of pipeline bubbles.

The invention is based particularly on the idea of adding to a pipeline bubble detection device a minimum execution clock cycle ascertainment unit and/or a real execution clock cycle ascertainment unit in order to allow relatively precise analysis of the occurrence of pipeline bubbles.

The microprocessor according to the invention is preferably suitable for allowing software developers to perform in-depth analysis of the quality of a program code in respect of the occurrence of pipeline conflicts.

Known methods for reducing pipeline bubbles allow many software developers to actively evaluate their contributions to the avoidance of pipeline conflicts only to a limited extent. A typical software developer is provided with a compiler, preconfigured for his project, for a static pipeline microarchitecture in a microprocessor. If his program code is merged with other program codes, he is hitherto able to estimate only inaccurately the degree to which his program code causes pipeline conflicts.

The microprocessor according to the invention and the method according to the invention have the particular advantage that feedback regarding the pipeline response or the occurrence of pipeline bubbles can be provided for a portion of a program code which has been selected by the software developer arbitrarily. In the case of a prescribed compiler for an available microprocessor with an optimized pipeline microarchitecture, this allows a software developer to analyze the extent to which a program portion is involved in the generation of pipeline conflicts relatively quickly and easily. This allows the program code to be improved to avoid pipeline bubbles. This can expediently be achieved by virtue of the compiler settings being optimized in combination with the optimization of the program code itself in the course of the verification of the program or program code by the software developer.

The pipeline microarchitecture preferably comprises at least portions of the controller of the microprocessor.

The term “handle” preferably covers the term “execute”.

The term “optimize” is expediently understood to mean optimization to avoid pipeline bubbles.

The number of clock cycles is preferably likewise or alternatively understood to mean an execution time, particularly a nondiscrete execution time.

The pipeline bubble detection device preferably additionally has a real execution clock cycle ascertainment unit for ascertaining the essentially actual number of execution clock cycles in which one or more program commands pass through the pipeline microarchitecture and/or are executed by the latter. In this case, the real execution clock cycle ascertainment unit comprises a counter element, in particular.

It is preferred for the command set of the microprocessor to have a pipeline bubble test start command and a pipeline bubble test stop command which can be used to actuate the pipeline bubble detection device such that a pipeline bubble test is started and ended, as a result of which the pipeline bubble detection device is accordingly activated and deactivated.

The minimum execution clock cycle ascertainment unit preferably has a machine code execution clock cycle association unit which ascertains the minimum number of execution clock cycles for the most recently loaded command from the machine code.

It is expedient for the pipeline bubble detection device and the pipeline microarchitecture to be designed such that, after the pipeline bubble test start command has been loaded into the pipeline microarchitecture and/or when the pipeline bubble test start command is executed in the pipeline microarchitecture, the minimum execution clock cycle ascertainment unit and the real execution clock cycle ascertainment unit are respectively started and these ascertain the minimum and real numbers of execution clock cycles for one or more commands, after which the minimum execution clock cycle ascertainment unit and the real execution clock cycle ascertainment unit are stopped when the pipeline bubble test stop command is loaded into the pipeline microarchitecture or executed in the latter or written back by the latter.

The real execution clock cycle ascertainment unit preferably has a monitor unit which, for each command handled by the pipeline microarchitecture, forms a difference from the actual number of execution clock cycles and the optimum number of execution clock cycles, which is ascertained by the minimum execution clock cycle ascertainment unit, if the pipeline bubble detection device is active, wherein the monitor unit has particularly a maximum value memory unit which stores the value of a maximum difference.

It is preferred for the pipeline bubble detection device to have a result memory unit, the input side of which is connected to the minimum execution clock cycle ascertainment unit and the real execution clock cycle ascertainment unit and in which the sum of the optimum number of execution clock cycles and/or the sum of the actual number of execution clock cycles and/or a difference between these sums is stored, wherein these sums relate to the execution of one or more program commands, particularly to all the program commands which pass through the pipeline microarchitecture and/or are executed by the latter and/or are handled by the latter during a single pipeline bubble test.

The method is expediently extended by virtue of the program which can be executed by the microprocessor having at least one pipeline bubble test start command and at least one pipeline bubble test stop command which actuate the minimum execution clock cycle ascertainment unit and a real execution clock cycle ascertainment unit in the pipeline bubble detection device and in this way start and end a pipeline bubble test, as a result of which the pipeline bubble detection device is activated and deactivated by virtue of, particularly after the pipeline bubble test start command has been loaded into the pipeline microarchitecture, the minimum execution clock cycle ascertainment unit and the real execution clock cycle ascertainment unit respectively being started and these ascertaining essentially the relevant minimum and real numbers of clock cycles for one or more commands, after which the minimum execution clock cycle ascertainment unit and the real execution clock cycle ascertainment unit are stopped when the pipeline bubble test stop command is loaded or executed or written back in the pipeline microarchitecture. With particular preference, the program code has a pipeline bubble test start command and a pipeline bubble test stop command, respectively, at various locations, as a result of which that portion of the program code which is enclosed by these two commands can be analyzed for the occurrence of pipeline bubbles and the relevant program code portion, quite particularly preferably in combination with the compiler settings, can be optimized.

It is expedient that the entire microprocessor according to the invention or individual modules or portions of said microprocessor are implemented as code, particularly as a bit code, which is used as actuation for a multipurpose logic chip, such as particularly preferably an FPGA (field-programmable gate array). Particularly when the numbers of items are relatively low, it is thus possible to save costs in comparison with the use of ASICs.

The invention furthermore relates to the use of the microprocessor in motor vehicles, particularly in motor vehicle control systems and/or safety systems, with particular preference in motor vehicle brake systems.

The invention is preferably intended for the optimization of program code by a software developer, particularly in a verification process for the program code.

Further preferred embodiments can be found in the subclaims and in the descriptions of exemplary embodiments which follow with reference to figures.

### BRIEF DESCRIPTION OF THE FIGURES

Schematically,

FIG. 1 shows an exemplary embodiment of a pipeline microarchitecture and of a pipeline bubble detection device associated therewith,

FIG. 2 shows exemplary command execution for a pipeline bubble test in a pipeline microarchitecture, and

FIG. 3 shows an exemplary program code, comprising a pipeline bubble test start command and a pipeline bubble test stop command, which allow the software developer to analyze the quality of the program code in respect of the occurrence of pipeline conflicts in a relatively flexible manner.

### DETAILED DESCRIPTION

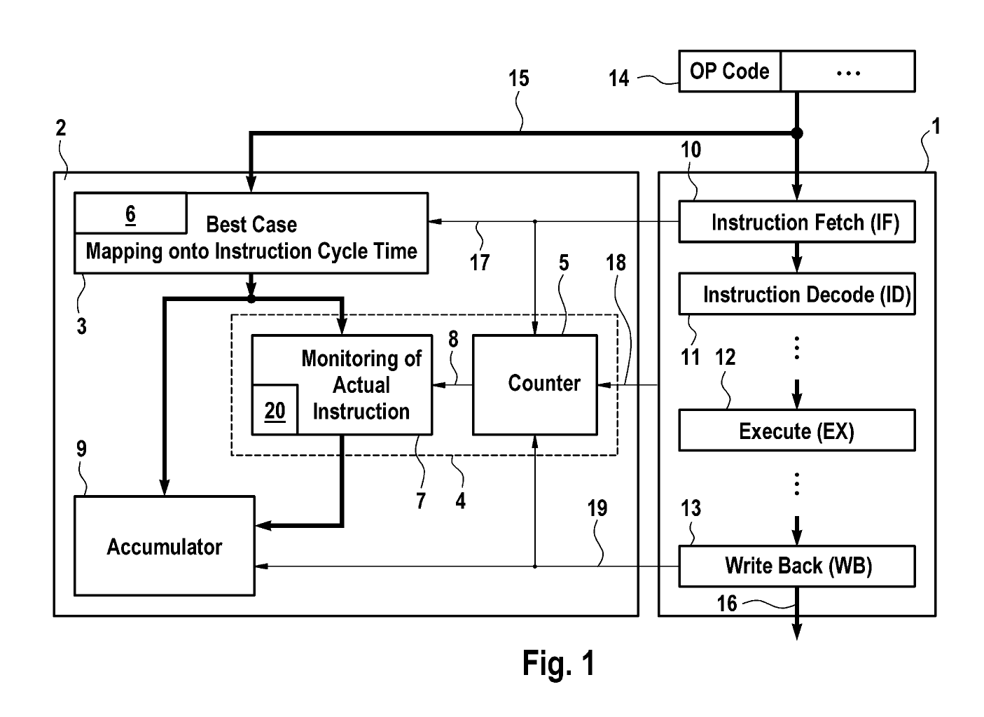

The pipeline microarchitecture 1 illustrated by way of example in FIG. 1 comprises various pipeline stages. Depending on the design of the pipeline microarchitecture, the number of stages can vary greatly. For example, FIG. 1 illustrates the following pipeline stages:
IF (Instruction Fetch) stage 10: The machine code or OP code 14 and the associated data, such as an operand or a destination address, are fed into this pipeline stage via the input bus 15.
ID (Instruction Decode) stage 11: When a command has been loaded or fetched, the command is decoded in this stage 11.
EX (Execution) stage 12: When a command has been decoded and identified, it is executed.
WB (Write Back) stage 13: In this stage, the result is written back to a register, for example, by means of the pipeline output bus 16 and possibly kept ready for further execution steps.

The pipeline microarchitecture 1 is connected to the pipeline bubble detection device 2. The commands fetched via the input bus 4 are also made available to the pipeline bubble detection device 2. As soon as the pipeline bubble test start command BTON is recognized, preferably in stage 10, IF or in stage 11, ID, the pipeline microarchitecture 1 uses the signal path 17 to trigger the pipeline bubble detection device 2 to start a pipeline bubble test, after which the pipeline bubble detection device 2 monitors the pipeline execution. In this context, the monitoring primarily involves ascertaining differences between the theoretically best or lowest number of clock cycle times and the number of actually accrued clock cycle times for command sequences. After the pipeline bubble detection device 2 is started, it determines the minimum or optimum number of clock cycles for each command fetched in step 10, IF using the minimum execution clock cycle ascertainment unit 3. For this purpose, the latter has a machine code execution clock cycle association unit 6 which the minimum execution clock cycle ascertainment unit 3 uses to deduce or determine the minimum number or theoretically best number of clock cycles for the command loaded in stage 10, IF from the bit values or from the OP code of the commands provided by the input bus 15. Using the signal path 17, the pipeline microarchitecture 1 notifies the minimum execution clock cycle ascertainment unit 3 when stage 10, IF has fetched a new command. The counter element 5 of the real execution clock cycle ascertainment unit 4 is connected to the pipeline microarchitecture 1 via signal paths 17, 18 and 19 and can therefore essentially ascertain the actually detected number of clock cycles for a command or for a plurality of program commands or commands. A difference between the actual number of execution clock cycles and the optimum number of execution clock cycles, ascertained by the minimum execution clock cycle ascertainment unit 3, for the current program command is formed by the monitor unit 7 of the real execution clock cycle ascertainment unit 4. The monitor unit 7 therefore provides the respective monitoring result for the most recently executed program command. In addition, the monitor unit comprises, on the basis of the example, a maximum value memory unit 20 which stores the value of a maximum difference for an executed command, that is to say the greatest difference between the theoretically lowest number of clock cycles and the actually accrued number of clock cycles. The input side of the result memory unit 9 (accumulator) is connected to the minimum execution clock cycle ascertainment unit 3 and to the real execution clock cycle ascertainment unit 4 and, on the basis of the example, stores the sum of the optimum number of execution clock cycles, the sum of the actual number of execution clock cycles and a difference between these sums in a respective register, these three sums relating to the execution of all the program commands which are executed during a single pipeline bubble test by the pipeline microarchitecture.

The result memory unit 9 is reset when the minimum execution clock cycle ascertainment unit 3 is triggered at the start of the pipeline bubble test. The pipeline bubble detection device 2 is active only during a pipeline bubble test and otherwise, that is to say in an inactive state, does not deliver any results. When a pipeline bubble test stop command BTOFF reaches the last stage 13, WB of the pipeline microarchitecture 1, it sends a stop signal to the pipeline bubble detection device 2. The respective pipeline bubble test is then at an end and the results obtained in the pipeline bubble detection device 2 remain unchanged until the next pipeline bubble test start command BTON is loaded or handled.

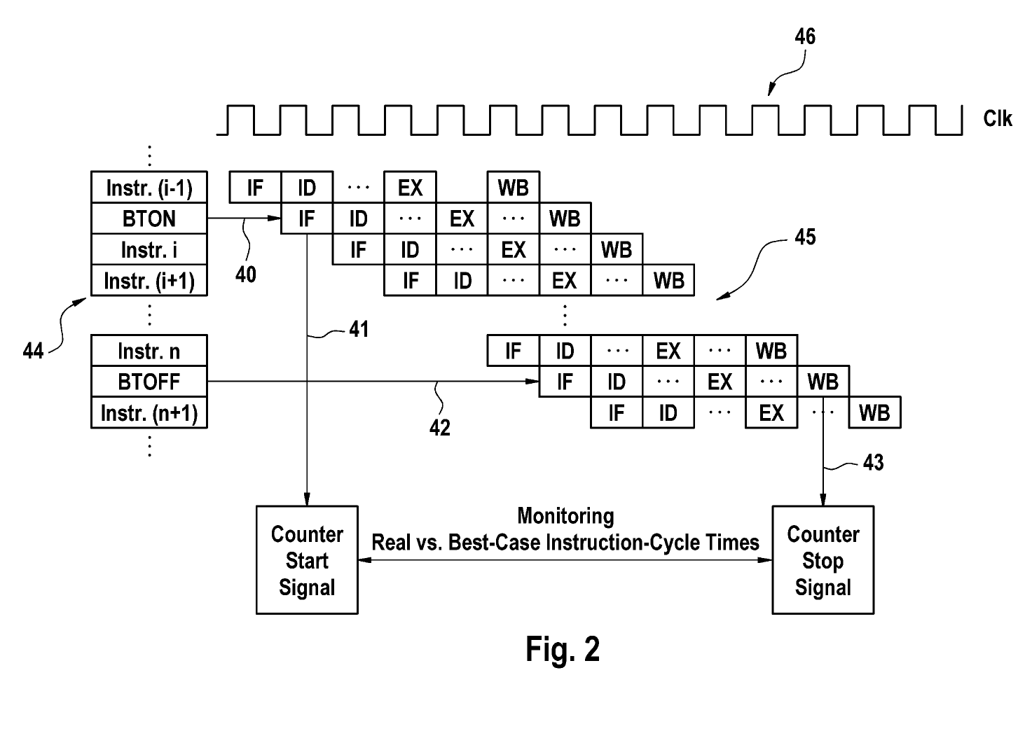

FIG. 2 illustrates an exemplary sequence for a pipeline bubble test which starts with the event 41 and ends with the event 43. The event 41 occurs after or when the pipeline bubble test start command BTON is fetched in stage 10, IF. When the pipeline bubble test stop command BTOFF command has reached the last pipeline stage WB or is written back, the event 43 occurs. This is illustrated by means of a schematic detail 44 from a program, which comprises the pipeline bubble test commands BTON and BTOFF, the relevant execution sequence for the commands in this program detail in a pipeline execution scheme 45 for the microprocessor clock 46, clk.

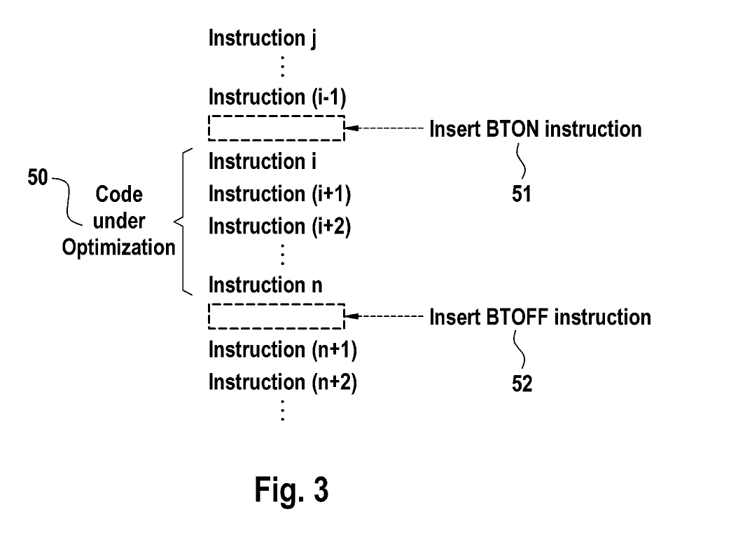

The method described above provides a software developer with relatively high flexibility in the selection of the portion of a program code 50 that is to be examined. FIG. 3 illustrates by way of example how a software developer can insert the pipeline bubble test commands BTON and BTOFF, 51 and 52, into the program code 50 arbitrarily.

While the above description constitutes the preferred embodiment of the present invention, it will be appreciated that the invention is susceptible to modification, variation, and change without departing from the proper scope and fair meaning of the accompanying claims.

In other embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of the invention. This description is not intended to limit the scope or application of the invention in that the invention is susceptible to modification, variation and change, without departing from spirit of the invention, as defined in the following claims.

1-10. (canceled)

11. A microprocessor, comprising:
a pipeline microarchitecture and a pipeline bubble detection device, and
wherein the pipeline bubble detection device has a minimum execution clock cycle ascertainment unit for ascertaining a minimum or an optimum number of execution clock cycles for one or more program commands which pass through the pipeline microarchitecture or are handled by the pipeline microarchitecture.

12. The microprocessor as claimed in claim 11, wherein the pipeline bubble detection device comprises a real execution clock cycle ascertainment unit having a counter element for ascertaining an essentially actual number of execution clock cycles in which one or more program commands pass through the pipeline microarchitecture or are executed by the pipeline microarchitecture.

13. The microprocessor as claimed in claim 12, wherein a command set of the microprocessor has a pipeline bubble test start command and a pipeline bubble test stop command is configured to actuate the pipeline bubble detection device such that a pipeline bubble test is started and ended, as a result of which the pipeline bubble detection device is accordingly activated and deactivated.

14. The microprocessor as claimed in claim 11, wherein the minimum execution clock cycle ascertainment unit has a machine code execution clock cycle association unit which ascertains a minimum number of execution clock cycles for a most recently loaded command from the machine code.

15. The microprocessor as claimed in claim 13, wherein the pipeline bubble detection device and the pipeline microarchitecture are configured such that, after the pipeline bubble test start command has been loaded into the pipeline microarchitecture or when the pipeline bubble test start command is executed in the pipeline microarchitecture, the minimum execution clock cycle ascertainment unit and the real execution clock cycle ascertainment unit are respectively started and ascertain the minimum and real numbers of execution clock cycles for one or more commands, after which the minimum execution clock cycle ascertainment unit and the real execution clock cycle ascertainment unit are stopped when the pipeline bubble test stop command is loaded into the pipeline microarchitecture or executed in the pipeline microarchitecture or written back by the pipeline microarchitecture.

16. The microprocessor as claimed in claim 13, wherein the real execution clock cycle ascertainment unit has a monitor unit which, for each command handled by the pipeline microarchitecture, forms a difference from the actual number of execution clock cycles and the optimum number of execution clock cycles, which is ascertained by the minimum execution clock cycle ascertainment unit, if the pipeline bubble detection device is active, wherein the monitor unit has a maximum value memory unit which stores the value of a maximum difference.

17. The microprocessor as claimed in claim 12, wherein the pipeline bubble detection device comprises a result memory unit, an input side of the result memory unit is connected to the minimum execution clock cycle ascertainment unit and the real execution clock cycle ascertainment unit and in which the sum of the optimum number of execution clock cycles or the sum of the actual number of execution clock cycles or a difference between these sums is stored, wherein these sums relate to the execution of one or more program commands, to all the program commands which pass through the pipeline microarchitecture or are executed by the pipeline microarchitecture or are handled by the pipeline microarchitecture during a single pipeline bubble test.

18. A method for actuating a microprocessor comprising a pipeline microarchitecture and a pipeline bubble detection device which provides information about the appearance of pipeline bubbles in the pipeline microarchitecture, the method comprising the steps of:
actuating a minimum execution clock cycle ascertainment unit in the pipeline bubble detection device, which ascertains a minimum or optimum number of execution clock cycles for one or more program commands which pass through the pipeline microarchitecture or are handled by the pipeline microarchitecture.

19. The method as claimed in claim 18, wherein the microprocessor has at least one pipeline bubble test start command and at least one pipeline bubble test stop command which actuate the minimum execution clock cycle ascertainment unit and a real execution clock cycle ascertainment unit in the pipeline bubble detection device and in this way start and end a pipeline bubble test, as a result of which the pipeline bubble detection device is activated and deactivated by virtue of, after the pipeline bubble test start command has been loaded into the pipeline microarchitecture, the minimum execution clock cycle ascertainment unit and the real execution clock cycle ascertainment unit respectively being started and these ascertaining essentially the relevant minimum and real numbers of clock cycles for one or more commands, after which the minimum execution clock cycle ascertainment unit and the real execution clock cycle ascertainment unit are stopped when the pipeline bubble test stop command is loaded or executed or written back in the pipeline microarchitecture.
